(19) United States
(12) Patent Application Publication
(10) Pub. No.: US 2011/0146469 A1
(43) Pub. Date: Jun. 23, 2011

(54) PIERCING TIP FOR SCRAP SHEAR

(76) Inventor: Brian Purser, Stoke-on-Trent (GB)

(21) Appl. No.: 12/641,371

(22) Filed: Dec. 18, 2009

(51) Int. Cl. B26D 1/38; B26D 7/26

(52) U.S. Cl. 83/456; 83/698.11; 83/694

(57) ABSTRACT

A piercing tip for a jaw of a shearing apparatus includes a main body having an open linear slot formed therein, and a complementary linear channel formed in the main body parallel to and open to the slot to capture within the channel an enlarged elongate head of a jaw of a shearing apparatus. A jaw for a shearing apparatus includes a raised rail, an enlarged elongate head positioned along the raised rail, and a piercing tip for piercing the scrap material upon movement of the jaw to the closed position. The piercing tip has a slot formed therein for receiving the raised rail and a widened channel formed in the slot for receiving the enlarged elongate head to maintain the engagement of the piercing tip with the second jaw.

### TECHNICAL FIELD OF THE INVENTION

This invention relates generally to an apparatus for reducing scrap materials, and more particularly to a piercing tip for a scrap shear.

### BACKGROUND OF THE INVENTION

Shears of various designs are attached to the mechanical arms of backhoes, earth-moving vehicles, and other industrial vehicles and are employed to sever, reduce, and move scrap materials for recycling or disposal. As with any bladed tool, the cutting and bearing edges of scrap shears are subject to wear and even destruction. The forces involved in piercing and shearing large metal waste structures are considerable, and so maintaining the machinery employed in metal reduction and recycling represents considerable costs. Machine operators are typically operating within a time schedule, and are often dealing with irregular piles of scrap and a variety of scrap configurations including rails, sheets, beams, and a wide variety of other scrap materials. Thus, the action at the cutting edges of shears employed in large scale metal scrap reduction is extreme, and causes not only the expected wear over time, but can lead to physical destruction of the shear blades, particularly at the tip.

Efficiency and success in scrap reduction therefore require durable and sharp tools and blades and tips that are convenient to replace and service. Prior art shear blade tips are typically attached to the shear blades by bolting them to one or both sides of the shear blade with bolts which extend laterally from one side of the shear tip to the other. The shear tip is both positioned and physically retained in place by the laterally-extending bolts. Forces bearing one the shear blade from all directions can deform, loosen and even detach such blade tips.

### BRIEF SUMMARY OF THE INVENTION

Accordingly, there is a need for an improved shearing apparatus, a jaw for a shearing apparatus, and a piercing tip for a jaw of a shearing apparatus. According to at least one embodiment of the invention, a piercing tip for a jaw of a shearing apparatus includes a main body having an open linear slot formed therein, and a complementary linear channel formed in the main body parallel to and open to the slot to capture within the channel an enlarged, elongate head of a jaw of a shearing apparatus.

In at least one example, the slot is formed along a longitudinal axis, the slot and the channel each have a perpendicular width with respect to the longitudinal axis; and the width of the channel is greater than the width of the slot to capture within the channel the enlarged elongate head of the jaw.

In at least one example, the main body has longitudinal first and second ends, and the slot and channel extend from the first end and terminate within the body without reaching the second end.

In at least one example, the slot and channel have rectangular cross sections.

In at least one example, wherein the slot and channel together have a T-shaped cross section.

In at least one example, the main body has at least one retainer hole formed therethrough open to the channel to receive a retainer to attach the main body to the jaw of the shearing apparatus.

According to at least one other embodiment of the invention, a jaw is provided for a shearing apparatus of the type having two opposing jaws, at least one of which is pivotally mounted to the shearing apparatus and is movable between a relatively open position for receiving scrap material and a closed position for bearing shear force upon the scrap material. The jaw includes a raised rail and an enlarged elongate head positioned along the raised rail, and a piercing tip for piercing the scrap material upon movement of the jaw to the closed position. The piercing tip has a slot formed therein for receiving the raised rail and a widened channel formed in the slot for receiving the enlarged elongate head to maintain engagement of the piercing tip with the second jaw.

In at least one example, the raised rail and the enlarged elongate head have complementary T-shaped cross sections.

In at least one example, the slot and channel together surround the raised rail and the enlarged elongate head.

In at least one example, the piercing tip has holes formed therethrough in position registration with corresponding threaded holes formed in the jaw, and connectors engaging the threaded holes attach the piercing tip to the jaw.

In at least one example, at least one bolt has a head countersunk into the piercing tip and has a threaded shank engaging the jaw to attach the piercing tip to the jaw.

In at least one example, a threaded insert is positioned in the jaw and engages the threaded shank.

According to yet another embodiment of the invention, a shearing apparatus for reducing scrap material includes a first member having a first jaw on an end thereof, a second member pivotally mounted to the first member for movement about a pivot axis, and a second jaw carried by the second member opposing the first jaw. The second jaw is movable about the pivot axis relative to the first jaw between a relatively open position for receiving scrap material between the first jaw and the second jaw and a closed position for bearing shear force upon the scrap material. A piercing tip is carried by the second jaw for piercing the scrap material upon movement of the second jaw to the closed position. The second jaw has a raised rail and an enlarged elongate head positioned along the raised rail, and the piercing tip has a slot formed therein for receiving the raised rail and a widened channel formed in the slot for receiving the enlarged elongate head to maintain engagement of the piercing tip with the second jaw.

### BRIEF DESCRIPTION OF THE DRAWINGS

The subject matter that is regarded as the invention may be best understood by reference to the following description taken in conjunction with the accompanying drawing figures in which:

FIG. 1 is an environmental perspective view of a shearing apparatus carried by the mechanical arm of an industrial vehicle and having a piercing tip according to at least one embodiment of the present invention;

FIG. 2 is a side view of the shearing apparatus of FIG. 1;

FIG. 3 is a perspective view of the piercing tip of FIG. 1;

FIG. 4 is an exploded perspective view of the piercing tip of FIG. 1 shown separate from and aligned for installation upon a jaw of the shearing apparatus of FIG. 1; and

FIG. 5 is a partially exploded perspective view of the piercing tip and jaw of FIG. 4 shown with bolts aligned to retain the piercing tip with the jaw.

### DETAILED DESCRIPTION OF THE INVENTION

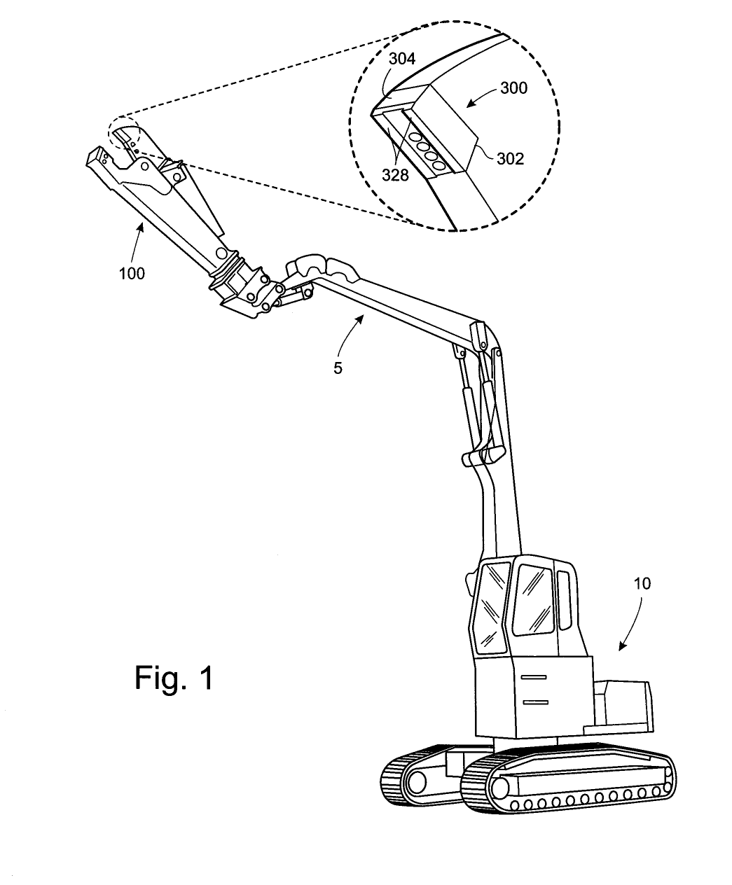

Referring to the drawings wherein identical reference numerals denote the same elements throughout the various views, FIG. 1 illustrates a shearing apparatus 100 according to one embodiment of the present invention. The shearing apparatus 100 is carried by the movable mechanical arm 5 of an industrial vehicle 10 and is positioned by the operator of the vehicle 10 to shear materials such as scrap metal.

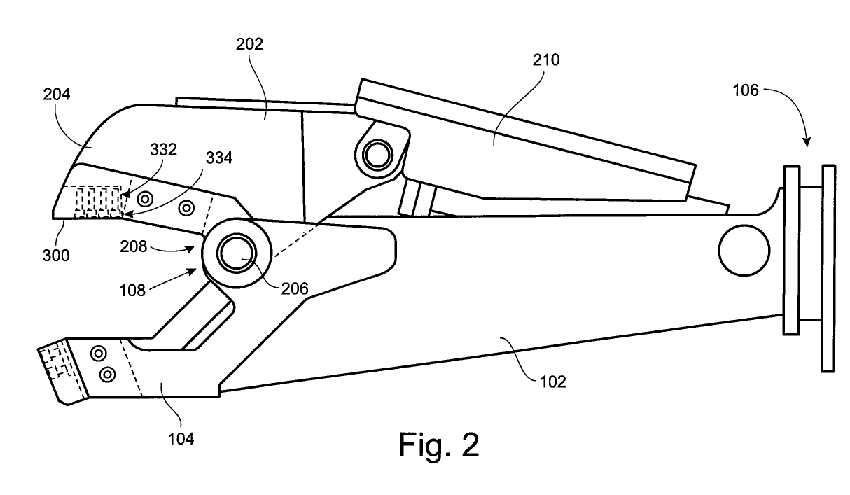

The shearing apparatus 100, as shown separately in FIG. 2, includes a first member 102 having a first jaw 104 and a mounting means 106 at the opposite end of the first member 102. The mounting means 106 attaches to the mechanical arm 5 of the industrial vehicle 10, such as the illustrated backhoe as shown in FIG. 1.

As is also shown in FIG. 2, the shearing apparatus 100 includes a second member 202 having a second jaw 204 that opposes the first jaw 104. The first and second members 102 and 202 have respective pivot brackets 108 and 208 that engage a pin 206 about which the second member 202 pivots relative to the first member 102 between a relatively open position as shown in FIG. 2 and a closed position where the first and second jaws 104 and 204 are brought to closer relation for bearing shear force upon scrap material between the jaws.

The second member 202 is pivotally attached to a cylinder assembly 210, which is pivotally attached to the first member 102 near the mounting means 106. The hydraulic cylinder assembly 210 is carried between portions of the first and second members 102 and 202 and by extension under the control of an operator moves the second jaw 204 toward the first jaw 104 as the second member 202 pivots about the pin 206. General operations of the shearing apparatus 100 include the positioning of the first and second jaws 104 and 204 around scrap material to be sheared and the extension of the cylinder assembly 210 to forcefully close the jaws 104 and 204 against the scrap material held in the jaws. The cylinder assembly 210 is powered by the pressured hydraulic system of the vehicle or industrial machine to which it is attached in use.

A piercing tip 300 is carried by the second jaw 204 for piercing scrap material as the jaws 104 and 204 are closed. The piercing tip 300 is removable from the second jaw 204 and can therefore be replaced or serviced when it is worn or damaged. However, the design of the piercing tip substantially reduces both wear and damage, as described below.

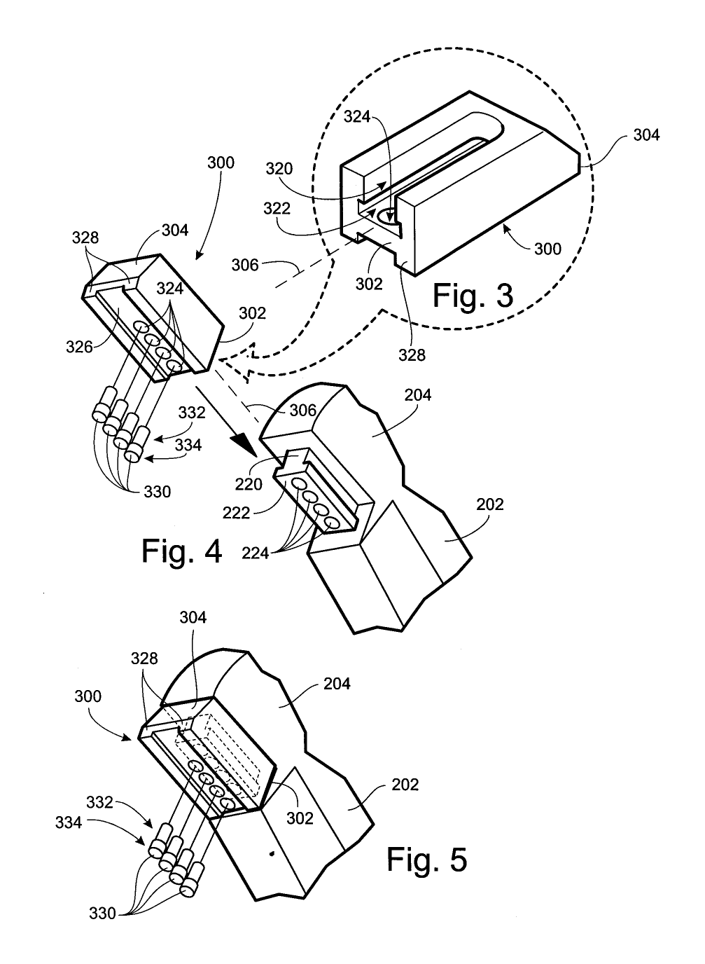

As shown in FIG. 3, the second jaw 202 includes a raised rail 220 having an enlarged head 222, commonly referred to as a “dovetail” configuration. The piercing tip 300 has a linear slot 320 and a widened, undercut, channel 322 corresponding respectively to the raised rail 220 and enlarged head 222. The slot 320 is formed along a longitudinal axis 306. The slot 320 and the widened channel 322, as shown, have rectangular cross sections with respect to the longitudinal axis. The widened channel 322 is wider than the slot 320 with respect to the axis 306, such that the slot 320 and channel 322 together have a T-shaped cross section. Other complementary shapes are also possible so long as the piercing tip 300 is mechanically retained on the end of the second jaw 204.

The raised rail 220 and enlarged head 222 of the second jaw 204 preferably also have rectangular cross sections, and together preferably have a T-shaped cross section corresponding to that of the slot 320 and channel 322 such that the piercing tip 300 can be slid upon the rail 220. The channel 322 and slot 320 capture the rail 220 and head 222 when the piercing tip 300 is positioned onto the jaw 204. The main body of the piercing tip 300 has longitudinal first and second ends 302 and 304. The slot 320 and channel 322 extend from the first end 302 toward the second end 304 parallel to the longitudinal axis 306, but the slot 320 and channel 322 terminate without reaching the second end 304. Thus the rail 220 and enlarged head 222 are shielded from all sides, and are not subject to contact with scrap as the shearing apparatus 100 is used. Wear and tear on the shearing apparatus 100 is therefore concentrated at the piercing tip 300, which is replaceable.

The piercing tip 300 is fixed in its position along the rail 220 by one or more connectors 330, which are illustrated in FIGS. 4 and 5 as bolts. The piercing tip 300 has holes 324 formed therethrough from the scrap contacting side 326 to the channel 322. The holes 324 are placed in position registration with corresponding threaded holes 224 in the rail 220 and head 222 when the piercing tip 300 is properly positioned on the jaw 202. The connectors 330 have threaded shanks 332 that engage the threaded holes 224 and heads 334 that fix the piercing tip 300 to the jaw 202 as shown in FIG. 2. The heads 334 are countersunk into the piercing tip 300 as shown in FIG. 2 so as to protect the heads 334 from wear and damage as the shearing apparatus 100 is used to shear scrap materials. It is therefore the case that the bolts need only retain the piercing tip 300 in its correct position—the principal manner of fixing the piercing tip 300 to the upper jaw 204 is by engagement of the linear slot 320 and widened, undercut, channel 322 with the raised rail 220 and enlarged head 222.

The threaded shanks 332 of the connectors 330 may directly engage the threaded holes 224 of the jaw 202, or there may be inserts positioned in the holes 224 having internal and external threads that respectively engage the connectors 330 and holes 224. For example, helicoils may be installed into the holes 224 so that the threaded engagement of the connectors 330 with the jaw 202 can be serviced by replacement of the helicoils. The piercing tip 300 includes ridges 328 extending outwardly from the scrap contacting side 326 to assist in the cutting of scrap and to protect the holes 324.

Although the raised rail 220 and enlarged head 222 of the second jaw 202 are illustrated as together having a T-shaped cross section corresponding to that of the piercing tip 300, which captures the enlarged head 222 in the channel 322, other shapes are within the scope of these descriptions according to other embodiments of the invention. For example, in another embodiment the raised rail 220 is shaped like a wedge with its head 222 being the widest portion and the slot 320 and channel 322 are correspondingly shaped so that a dovetail joint is formed when the piercing tip 300 is slid onto the rail 220.

While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A piercing tip for a jaw of a shearing apparatus comprising:
(a) a main body having an open linear slot formed therein; and
(b) a widened linear channel formed in the main body parallel to and open to the slot to capture within the channel a complementary-shaped elongate head of a jaw of a shearing apparatus.

2. A piercing tip according to claim 1, wherein:
(a) the slot is formed along a longitudinal axis;
(b) the slot and the channel each have a perpendicular width with respect to the longitudinal axis; and
(c) the width of the channel is greater than the width of the slot to capture within the channel the enlarged elongate head of the jaw.

3. A piercing tip according to claim 1, wherein the main body has longitudinal first and second ends, and wherein the slot and channel extend from the first end and terminate within the body without reaching the second end.

4. A piercing tip according to claim 1, wherein the slot and channel have rectangular cross sections.

5. A piercing tip according to claim 1, wherein the slot and channel together have a T-shaped cross section.

6. A piercing tip according to claim 1, wherein the main body has at least one hole formed therethrough open to the channel to receive a connector to attach the main body to the jaw of the shearing apparatus.

7. A jaw for a shearing apparatus of the type having two opposing jaws, at least one of which is pivotally mounted to the shearing apparatus and is movable between a relatively open position for receiving scrap material and a closed position for bearing shear force upon the scrap material, the jaw comprising:
(a) a raised rail and an enlarged elongate head positioned along the raised rail;
(b) a piercing tip carried on the jaw for piercing the scrap material upon movement of the jaw to the closed position; and
(c) wherein the piercing tip has a slot formed therein for receiving the raised rail and a widened channel formed in the slot for receiving the enlarged elongate head to maintain engagement of the piercing tip with the second jaw.

8. A jaw according to claim 7, wherein the piercing tip has longitudinal first and second ends, and wherein the slot and channel extend from the first end and terminate without reaching the second end.

9. A jaw according to claim 7, wherein the slot and channel have rectangular cross sections.

10. A jaw according to claim 7, wherein the slot and channel together have a T-shaped cross section.

11. A jaw according to claim 7, wherein the raised rail and the enlarged elongate head together have a T-shaped cross section.

12. A jaw according to claim 7, the slot and channel together surround the raised rail and the enlarged elongate head.

13. A jaw according to claim 7, wherein the piercing tip has holes formed therethrough in position registration with corresponding threaded holes formed in the jaw, and wherein connectors engaging the threaded holes attach the piercing tip to the jaw.

14. A jaw according to claim 7, further comprising at least one bolt having a head countersunk into the piercing tip and having a threaded shank engaging the jaw to attach the piercing tip to the jaw.

15. A jaw according to claim 14, further comprising a threaded insert positioned in the jaw and engaging the threaded shank.

16. A shearing apparatus for reducing scrap material comprising:
(a) a first member having a first jaw on an end thereof;
(b) a second member pivotally mounted to the first member for movement about a pivot axis;
(c) a second jaw carried by the second member opposing the first jaw, the second jaw being movable about the pivot axis relative to the first jaw between a relatively open position for receiving scrap material between the first jaw and the second jaw and a closed position for bearing shear force upon the scrap material;
(d) a piercing tip carried by the second jaw for piercing the scrap material upon movement of the second jaw to the closed position;
(e) wherein the second jaw has a raised rail and an enlarged elongate head positioned along the raised rail; and
(f) wherein the piercing tip has a slot formed therein for receiving the raised rail and a widened channel formed in the slot for receiving the enlarged elongate head to maintain engagement of the piercing tip with the second jaw.

17. A shearing apparatus according to claim 16, wherein the piercing tip has longitudinal first and second ends, and wherein the slot and channel extend from the first end and terminate without reaching the second end.

18. A jaw according to claim 16, wherein the slot and channel have rectangular cross sections.

19. A jaw according to claim 16, wherein the slot and channel together have a T-shaped cross section.

20. A jaw according to claim 7, wherein the raised rail and the enlarged elongate head together have a T-shaped cross section.
